(19) United States
(12) Patent Application Publication
(10) Pub. No.: US 2014/0047526 A1
(43) Pub. Date: Feb. 13, 2014

(54) ELECTRONIC DEVICE AND METHOD FOR PROVIDING CLOUD COMPUTING SERVICES

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventor: Hung-Chi HUANG, New Taipei (TW)

(21) Appl. No.: 13/928,752

(22) Filed: Jun. 27, 2013

(30) Foreign Application Priority Data
Aug. 10, 2012 (TW) 101128910

(51) Int. Cl. H04L 29/06

(52) U.S. Cl. CPC H04L 63/083
USPC 726/7

(57) ABSTRACT

In a method for providing cloud computing services using an electronic device, the electronic device connects to a cloud server through a network, and the cloud server connects to a cloud storage system. The electronic device includes a slave operating system (OS), a streamer agent, and a touch screen. The cloud server assigns an IP address and a security code to the electronic device using a hypervisor of the cloud server. The slave OS receives an account and a password inputted from a user operation interface, and verifies whether the account and password are valid according to the security code. The electronic device uploads data to the cloud server by the streamer agent, downloads data from the cloud storage system by the streamer agent, and displays the downloaded data on the touch screen and each display device that is wirelessly connected to the electronic device.

### BACKGROUND

1. Technical Field

Embodiments of the present disclosure relate to cloud computing systems and methods, and particularly to an electronic device and method for providing cloud computing services.

2. Description of Related Art

Cloud computing provides computation, software, data access, and storage services that do not require end-user knowledge of the physical location and configuration of the cloud computing system that delivers the services. Cloud computing describes a new supplement, consumption, and delivery model for IT services based on Internet protocols, and it typically involves provisioning of dynamically scalable and often virtualized resources. Cloud computing providers deliver applications via the Internet, which are accessed from various terminal devices, while the applications and data files are stored on servers at remote locations.

Most cloud computing infrastructures consist of services delivered through shared data-centers and appearing as a single point of access for computing needs of consumers. Data files can be stored in a cloud storage that is accessible by the terminal devices when the terminal devices are connected to the Internet. However, some terminal devices (such as mobile phones having weak computing power) and need to use more time and resources to share the cloud computing services, so as to limit the usefulness of cloud computing services. Therefore, there is room for improvement within the cloud computing system.

### BRIEF DESCRIPTION OF THE DRAWINGS

FIG. 1 is a block diagram of one embodiment of an electronic device including a cloud computing system.

FIG. 2 is a block diagram illustrating function modules of the cloud computing system included in the electronic device of FIG. 1.

FIG. 3 is a flowchart of one embodiment of a method for providing cloud computing services using the electronic device of FIG. 1.

FIG. 4 is a detailed flowchart of step S36 in FIG. 3.

FIG. 5 is a detailed flowchart of step S37 in FIG. 3.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage system. Some non-limiting examples of a non-transitory computer-readable medium include CDs, DVDs, flash memory, and hard disk drives.

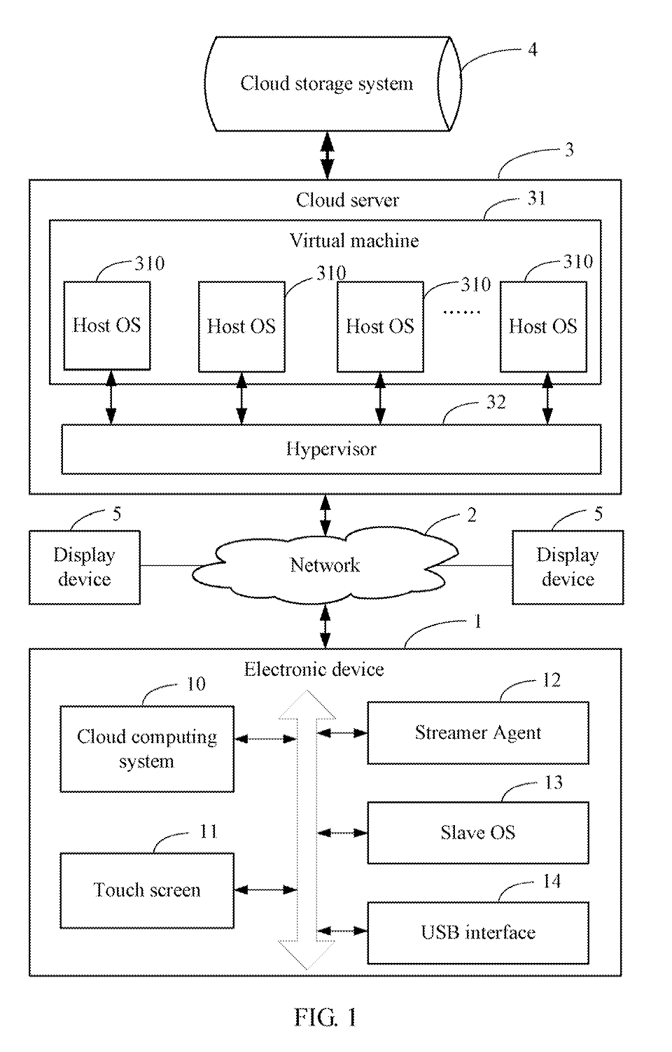

FIG. 1 is a block diagram of one embodiment of an electronic device 1 including a cloud computing system 10. In the embodiment, the cloud computing system 10 is implemented by the electronic device 1, which connects to a cloud server 3 through a network 2. The network 2 may be a wireless network such as a WIFI network or the Internet. The cloud server 3 provides cloud computing services including computation, software, data access, and storage services for terminal devices, such as one or more electronic devices 1. The cloud server 3 connects to a cloud storage system 4 through the Internet. The electronic device 1 connects to one or more display devices 5 through the network 2, and synchronously displays data downloaded from the cloud server 3 on the touch screen 11 and each of the display devices 5. In the embodiment, each of the display devices 5 may be a terminal monitor or a terminal display screen in remote locations.

In one embodiment, each of the electronic devices 1 may be a personal computer (PC), a notebook, a mobile phone, a PAD device or any other mobile device. The electronic device 1 further includes, but is not limited to, a touch screen 11, a streamer agent 12, a slave operating system (OS) 13 and a USB interface 14. The touch screen 11 provides a single touch operation or a multi-touch operation for users. The streamer agent 12 sends data to the cloud server 3 or receives data from the cloud server 3 through network 2. The slave OS 13 has basic functions of an ordinary OS, such as providing a WIFI function, a USB function, and a secure digital memory card (hereinafter referred to as SD card) storage function for the electronic device 1. The USB interface 14 loads data from an external storage media (such as an SD card) to the electronic device 1, and stores the data of the electronic device 1 to the external storage media.

In one embodiment, the cloud server 3 includes, but is not limited to, a virtual machine 31 and a hypervisor 32. The virtual machine 31 includes a plurality of host OS 310, each host OS 310 has a unique domain name server (DNS) corresponding to the electronic device 1. Each host OS 310 communicates with the slave OS 13 of the electronic device 1 to provide various cloud computing services for the electronic device 1. The hypervisor 32 may include a DHCP server for assigning an IP address to the electronic device 1 when the electronic device 1 connects to the cloud server 3 through the network 2, and assigns a host OS 310 for the electronic device 1 to communicate with the slave OS 13 according to the IP address.

The cloud storage system 4 stores data that are uploaded or downloaded from the electronic device 1, and applications that can be shared with the electronic device 1. The electronic device 1 can upload data to the cloud storage system 4 and download data from the cloud storage system 4 when the electronic device 1 connects to the cloud server 1 to share cloud computing services.

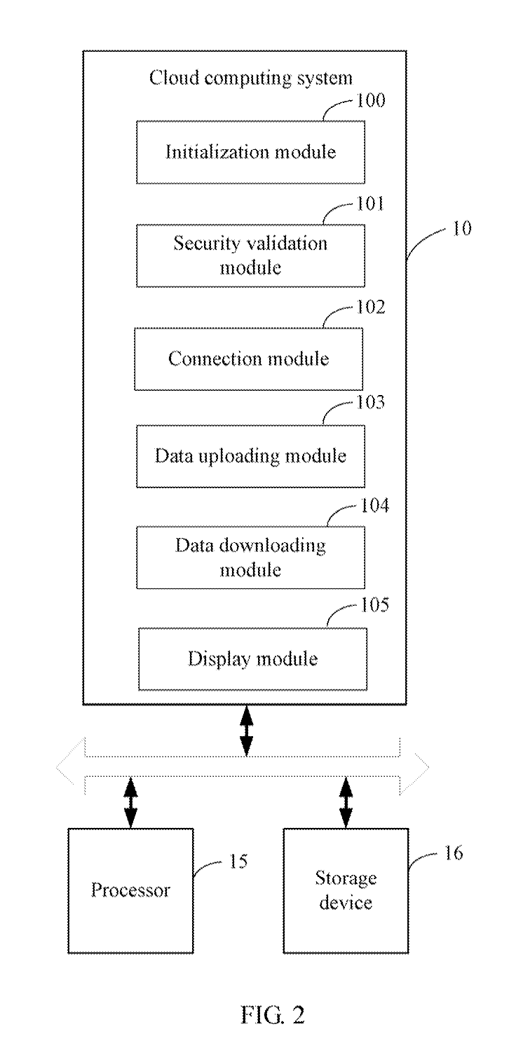

FIG. 2 is a block diagram illustrating function modules of the cloud computing system 10 included in the electronic device 1. In one embodiment, the electronic device 1 may further include at least one processor 15 and a storage device 16. In one embodiment, the storage device 16 may be an internal storage system, such as a random access memory (RAM) for temporary storage of information, and/or a read only memory (ROM) for permanent storage of information. The storage device 16 may also be an external storage system, such as an external hard disk, a storage card, or a data storage medium. The at least one processor 15 is a central processing unit (CPU) or microprocessor that performs various functions of the electronic device 1.

In the embodiment, the cloud computing system 10 includes an initialization module 100, a security verifying module 101, a connection module 102, a data uploading module 103, a data downloading module 104, and a display module 105. The modules 101-105 may comprise computerized instructions in the form of one or more programs that are stored in the storage device 16 and executed by the at least one processor 15. A description of each module is given in the following paragraphs.

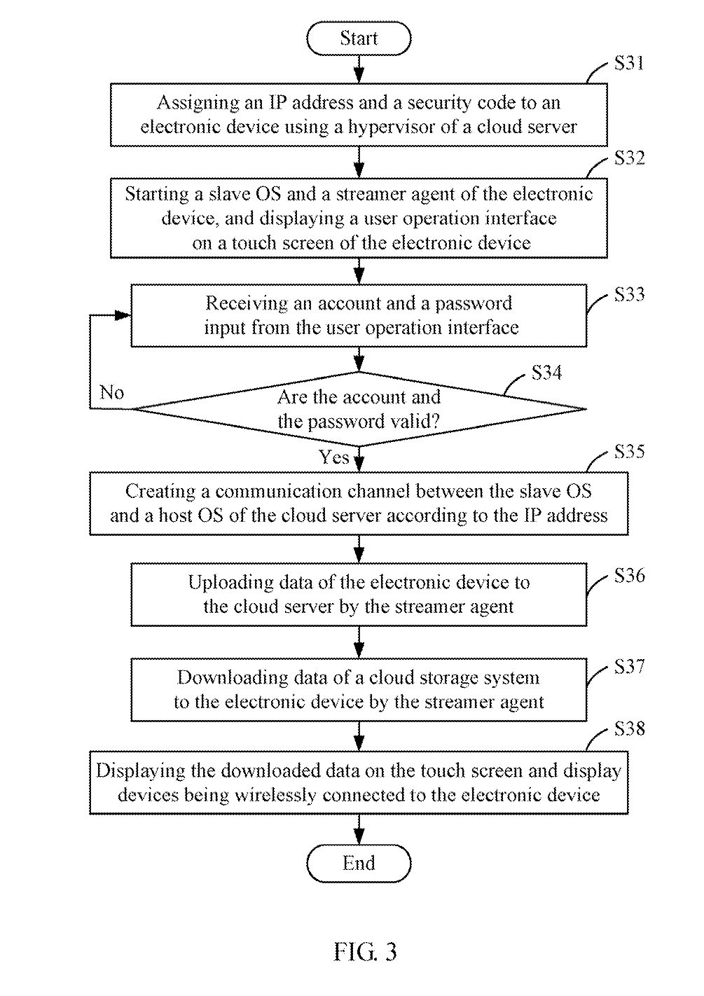

FIG. 3 is a flowchart of one embodiment of a method for providing cloud computing services using the electronic device 1 of FIG. 1. The method is performed by execution of computer-readable program codes or instructions by the at least one processor 15 of the electronic device 1. The method provides a WIFI function, a USB function, a multi-touch operation, and an SD card storage function for the electronic device 1 using the slave OS 13. Depending on the embodiment, additional steps may be added, others removed, and the ordering of the steps may be changed.

In step S31, the initialization module 100 assigns an IP address and a security code to the electronic device 1 using the hypervisor 32 of the cloud server 3. For example, the cloud server 3 assigns an address 10.102.101.20 as the IP address to the electronic device 1, and assigns a user-account and a password as the security code to the electronic device 1.

In step S32, the initialization module 100 starts the slave OS 13 to display a user operation interface on the touch screen 11 of the electronic device 1. In the embodiment, the user needs to input an account and the password on the user operation interface when the electronic device 1 connects to the cloud server 3.

In step S33, the security verifying module 101 receives the account and the password input from the user operation interface. In the embodiment, the account and password can be inputted by a touch operation on the user operation interface displayed on the touch screen 11 of the electronic device 1.

In step S34, the security verifying module 101 determines whether the inputted account and password are valid according to the security code. If the inputted account and password are valid, step S35 is implemented. Otherwise, if the inputted account and password are invalid, the process goes back to step S33.

In step S35, the connection module 102 creates a communication channel between the slave OS 13 and a host OS 310 of the cloud server 31 according to the IP address. If the electronic device is assigned the 10.102.101.20 IP address, the host OS 310 corresponding to the IP address communicates with the slave OS 13 of the electronic device 1.

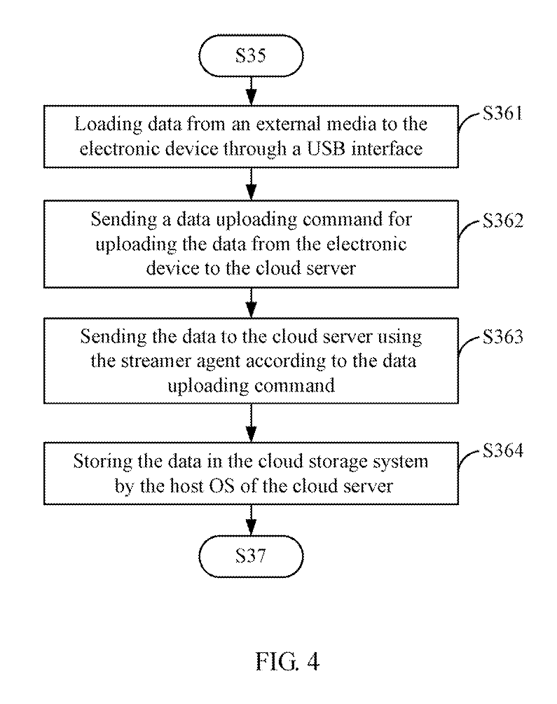

In step S36, the data uploading module 103 uploads data of the electronic device 1 to the cloud server 3 by using the streamer agent 12. In the embodiment, the cloud server 3 stores the uploaded data to the cloud storage system 4 when the cloud server 3 receives the data from the electronic device 1. The description of step S36 is illustrated in FIG. 4.

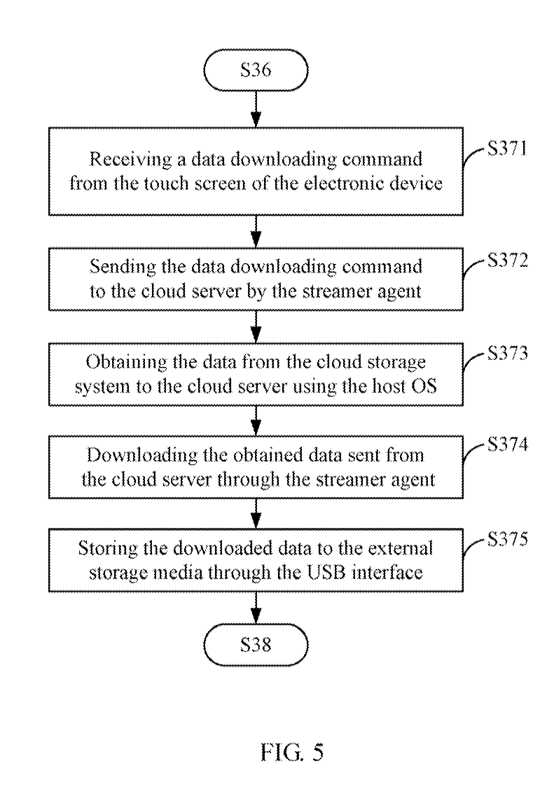

In step S37, the data downloading module 104 downloads data from the cloud storage system 4 to the electronic device 1 by using the streamer agent 12. In the embodiment, the cloud server 3 obtains the data from the cloud storage system 4 when the cloud server 3 receives a downloading data request from the electronic device 1. The description of step S37 is illustrated in FIG. 5.

In step S38, the display module 105 displays the downloaded data on the touch screen and the one or more display devices 5 that are wirelessly connected to the electronic device 1. In the embodiment, the display module 105 can synchronously display the downloaded data on the touch screen and each of the display devices 5.

FIG. 4 is a detailed flowchart of step S36 in FIG. 3. In step S361, the data uploading module 103 loads data from an external media (such as a SD card) to the electronic device 1 through the USB interface 14. The data may be images, audio files or video files that need to be stored in the cloud storage system 4. In step S362, the data uploading module 103 sends a data uploading command for uploading the data from the electronic device 1 to the cloud server 3. The data uploading command is inputted from the touch screen 11 of the electronic device 1. In step S363, the data uploading module 103 sends the loaded data to the cloud server 3 using the streamer agent 12 according to the data uploading command. In step S364, the data uploading module 103 stores the data in the cloud storage system 4 by the host OS 310 of the cloud server 3 when the cloud server 3 receives the uploaded data from the electronic device 1 through the network 2.

FIG. 5 is a detailed flowchart of step S37 in FIG. 3. In step S371, the data downloading module 104 receives a data downloading command inputted from the touch screen 11 of the electronic device 1. The data downloading command is used for downloading data from the cloud server 3 to the electronic device 1. In step S372, the data downloading module 104 sends the data downloading command to the cloud server 3 by the streamer agent 12 of the electronic device 1. In step S373, the virtual machine 31 of the cloud server 3 obtains the data from the cloud storage system 4 using the host OS 310 of the virtual machine 31 when the data downloading command is received from the electronic device 1. In step S374, the data downloading module 104 downloads the obtained data from the cloud server 3 through the streamer agent 12. In step S375, the data downloading module 104 stores the downloaded data to the external storage media (such as the SD card) through the USB interface 14 of the electronic device 1, so that the data downloaded from the cloud storage system 4 can be transferred and stored in the storage media.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device being connected to a cloud server through a network, the cloud server connected to a cloud storage system, the electronic device comprising:
a slave operating system (OS), a streamer agent, and a touch screen;
at least one processor; and
a storage device storing one or more computer-readable program instructions, which when executed by the at least one processor, causes the at least one processor to:
assign an IP address and a security code to the electronic device using a hypervisor of the cloud server;
start the slave OS to display a user operation interface on the touch screen;
receive an account and a password inputted from the user operation interface, and verify whether the inputted account and password are valid according to the security code;
create a communication channel between the slave OS and a host OS of the cloud server according to the IP address, if the inputted account and password are valid;
upload data of the electronic device to the cloud server by using the streamer agent;
download data of the cloud storage system to the electronic device by using the streamer agent; and
display the downloaded data on the touch screen and one or more display devices that are wirelessly connected to the electronic device.

2. The electronic device according to claim 1, wherein the slave OS provides a WIFI function, a universal serial bus (USB) function, a multi-touch operation, and a secure digital memory (SD) card storage function for the electronic device.

3. The electronic device according to claim 1, wherein the cloud server comprises a virtual machine that includes a plurality of host operating systems (OS), and each host OS has a unique domain name server (DNS) corresponding to the slave OS to provide various cloud computing services for the electronic device.

4. The electronic device according to claim 1, further comprising a USB interface that loads the uploaded data from an external storage media to the electronic device, and stores the downloaded data of the electronic device to the external storage media.

5. The electronic device according to claim 4, wherein uploading data from the electronic device to the cloud server comprises:
loading data from an external media to the electronic device through the USB interface;
sending a data uploading command for uploading the data from the electronic device to the cloud server;
sending the loaded data to the cloud server using the streamer agent according to the data uploading command; and
storing the data in the cloud storage system by the host OS of the cloud server when the cloud server receives the uploaded data from the electronic device through the network.

6. The electronic device according to claim 4, wherein downloading data from the cloud storage system to the electronic device comprises:
receiving a data downloading command from the touch screen of the electronic device;
sending the data downloading command to the cloud server by the streamer agent of the electronic device;
obtaining the data from the cloud storage system using the host OS of the cloud server when the data downloading command is received from the electronic device;
downloading the obtained data from the cloud server through the streamer agent; and
storing the downloaded data to the external storage media through the USB interface of the electronic device.

7. A method for providing cloud computing services using an electronic device, the electronic device being connected to a cloud server through a network, the cloud server connected to a cloud storage system, the method comprising:
assigning an IP address and a security code to the electronic device using a hypervisor of the cloud server;
starting a slave OS of the electronic device to display a user operation interface on a touch screen of the electronic device;
receiving an account and a password inputted from the user operation interface, and verifying whether the inputted account and password are valid according to the security code;
creating a communication channel between the slave OS and a host OS of the cloud server according to the IP address, if the inputted account and password are valid;
uploading data of the electronic device to the cloud server by using a streamer agent of the electronic device;
downloading data of the cloud storage system to the electronic device by using the streamer agent; and
displaying the downloaded data on the touch screen and one or more display devices that are wirelessly connected to the electronic device.

8. The method according to claim 7, wherein the slave OS provides a universal serial bus (USB) function, a multi-touch operation, and a secure digital memory (SD) card storage function for the electronic device.

9. The method according to claim 7, wherein the cloud server comprises a virtual machine that includes a plurality of host operating systems (OSs), and each host OS has a unique domain name server (DNS) corresponding to the slave OS to provide various cloud computing services for the electronic device.

10. The method according to claim 7, wherein the electronic device further comprises a USB interface that loads the uploaded data from an external storage media to the electronic device, and stores the downloaded data of the electronic device to the external storage media.

11. The method according to claim 10, wherein uploading data from the electronic device to the cloud server comprises:
loading data from an external media to the electronic device through the USB interface;
sending a data uploading command for uploading the data from the electronic device to the cloud server;
sending the loaded data to the cloud server using the streamer agent according to the data uploading command; and
storing the data in the cloud storage system by the host OS of the cloud server when the cloud server receives the uploaded data from the electronic device through the network.

12. The method according to claim 10, wherein downloading data from the cloud storage system to the electronic device comprises:
receiving a data downloading command from the touch screen of the electronic device;
sending the data downloading command to the cloud server by the streamer agent of the electronic device;
obtaining the data from the cloud storage system using the host OS of the cloud server when the data downloading command is received from the electronic device;
downloading the obtained data from the cloud server through the streamer agent; and
storing the downloaded data to the external storage media through the USB interface of the electronic device.

13. A non-transitory storage medium having stored thereon instructions that, when executed by at least one processor of an electronic device, cause the electronic device to perform a method for providing cloud computing services, the electronic device being connected to a cloud server through a network, the cloud server connected to a cloud storage system, the method comprising:
assigning an IP address and a security code to the electronic device using a hypervisor of the cloud server;
starting a slave OS of the electronic device to display a user operation interface on a touch screen of the electronic device;
receiving an account and a password inputted from the user operation interface, and verifying whether the inputted account and password are valid according to the security code;
creating a communication channel between the slave OS and a host OS of the cloud server according to the IP address, if the inputted account and password are valid;
uploading data of the electronic device to the cloud server by using a streamer agent of the electronic device;
downloading data of the cloud storage system to the electronic device by using the streamer agent; and
displaying the downloaded data on the touch screen and one or more display devices that are wirelessly connected to the electronic device.

14. The storage medium according to claim 13, wherein the slave OS provides a universal serial bus (USB) function, a multi-touch operation, and a secure digital memory (SD) card storage function for the electronic device.

15. The storage medium according to claim 13, wherein the cloud server comprises a virtual machine that includes a plurality of host operating systems (OS), and each host OS has a unique domain name server (DNS) corresponding to the slave OS to provide various cloud computing services for the electronic device.

16. The storage medium according to claim 13, wherein the electronic device further comprises a USB interface that loads the uploaded data from an external storage media to the electronic device, and stores the downloaded data of the electronic device to the external storage media.

17. The storage medium according to claim 16, wherein uploading data from the electronic device to the cloud server:
loading data from an external media to the electronic device through the USB interface;
sending a data uploading command for uploading the data from the electronic device to the cloud server;
sending the loaded data to the cloud server using the streamer agent according to the data uploading command; and
storing the data in the cloud storage system by the host OS of the cloud server when the cloud server receives the uploaded data from the electronic device through the network.

18. The storage medium according to claim 16, wherein downloading data from the cloud storage system to the electronic device comprises:
receiving a data downloading command from the touch screen of the electronic device;
sending the data downloading command to the cloud server by the streamer agent of the electronic device;
obtaining the data from the cloud storage system using the host OS of the cloud server when the data downloading command is received from the electronic device;
downloading the obtained data from the cloud server through the streamer agent; and
storing the downloaded data to the external storage media through the USB interface of the electronic device.
